(19) United States
(12) Patent Application Publication
(10) Pub. No.: US 2017/0168306 A1
(43) Pub. Date: Jun. 15, 2017

(54) Device and method for testing function or use of a head worn see through augmented reality device

(71) Applicant: Airbus Defence and Space GmbH, Taufkirchen (DE)

(72) Inventors: Daniel Dreyer, Hohenkammer (DE); Matthias Oberhauser, Muenchen (DE); Andreas Pruecklmeier, Muenchen (DE); Sebastien Mamessier, Voisins le Bretonneux (FR)

(21) Appl. No.: 15/372,624

(22) Filed: Dec. 8, 2016

(30) Foreign Application Priority Data
Dec. 9, 2015 (EP) 15198726.0

(51) Int. Cl. G02B 27/01; G06F 3/01; G02B 27/00

(52) U.S. Cl. CPC G02B 27/0179; G02B 27/0176; G02B 27/0093; G06F 3/012

(57) ABSTRACT

A method and device to create a realistic and flexible test environment for the evaluation of augmented reality application and device. The test method and the test device for testing the function and/or use of a head worn see through augmented reality device by means of a virtual reality environment, comprises a head mounted device. The head mounted display includes a virtual reality head mounted display configured to display the virtual reality environment to the eyes of a user through the head worn see through augmented reality device, and an alignment device to align the head mounted display and the head worn see through augmented reality device.

### CROSS-REFERENCES TO RELATED APPLICATIONS

This application claims the benefit of the European patent application No. 15198726.0 filed on Dec. 9, 2015, the entire disclosures of which are incorporated herein by way of reference.

### BACKGROUND OF THE INVENTION

The invention relates to a test device for testing use of a head worn see through augmented reality device. Further, the invention relates to a test method for testing use of a head worn see through augmented reality device.

Augmented reality (AR) is a technique to enrich a real-world environment with computer generated information. This information can be conformal information, i.e., elements that are spatially related to real-world objects, or information that is just a static overlay without reference to a real world object. In the aviation sector AR is widely known and has been used for decades in Head-Up -Displays and/or Head-Mounted-Displays especially in military aviation. With recent developments like smartphones and affordable head worn devices, more applications of AR emerged.

With regard to the background prior art, reference is made to the following documents:

[1] Tiefenbacher, Philipp, Nicolas H. Lehment, and Gerhard Rigoll. “Augmented reality evaluation: A concept utilizing virtual reality.” Virtual, Augmented and Mixed Reality. Designing and Developing Virtual and Augmented Environments. Springer International Publishing, 2014. 226-236.

[2] Oberhauser, Matthias, et al. “Bridging the Gap Between Desktop Research and Full Flight Simulators for Human Factors Research.” Engineering Psychology and Cognitive Ergonomics. Springer International Publishing, 2015. 460-471.

[3] unpublished German patent application DE 10 2015 103 735.1.

[4] U.S. Pat. No. 5,257,094 A

Document [1] discloses an evaluation environment for handheld AR devices in a CAVE environment. This known demonstrator uses an expensive and inflexible CAVE environment.

### SUMMARY OF THE INVENTION

It is an object of the invention to create a realistic and flexible test environment for the evaluation of augmented reality application and devices.

According to one aspect, the invention provides a test device for testing function and/or use of a head worn see through augmented reality device by means of a virtual reality environment, comprising a head mounted device including a virtual reality head mounted display configured to display the virtual reality environment to the eyes of a user through the head worn see through augmented reality device and an alignment device to align the head mounted display and the head worn see through augmented reality device.

It is preferred that the alignment device comprises a positioning means to position the virtual reality head mounted display with regard to the see through augmented reality device.

It is preferred that the head mounted device comprises a recess or slot configured to receive the see through augmented reality device in a positively engaged manner

A preferred embodiment has a head worn see through augmented reality device configured to display an augmented reality content to the user and attached to the head mounted device.

It is preferred that the virtual reality head mounted display has a field of view being larger than or equal to the field of view of the see through augmented reality device.

It is preferred that the virtual reality head mounted display and the see through augmented reality device are configured such that the head mounted display displays a virtual reality environment content aligned and/or correlated with an augmented reality content displayed by the see through augmented reality device.

It is preferred that the virtual reality head mounted display and the see through augmented reality device are binocular.

It is preferred that a collimation distance of the see through augmented reality device is set to be smaller or equal to a collimation distance of the virtual reality head mounted display.

It is preferred that the values of vergence angles of the see through augmented reality device and of the virtual reality head mounted display are aligned.

A preferred embodiment has at least one tracking sensor for tracking a position and/or orientation of the head of the user wherein the virtual reality head mounted display is configured to display the virtual reality content in dependence of an output of the tracking sensor.

It is preferred that the test device is configured such that the same sensor information can be used for driving both the image of the virtual reality head mounted display and the image of the see through augmented reality device.

It is preferred that the test device is configured such that the sensor information of the tracking sensor is only used for driving the image of the virtual reality head mounted display but not of the image of the see through augmented reality device in order to test an internal position and/or orientation sensor of the see through augmented reality device.

It is preferred that the test device is configured such that rotation and/or translation of the augmented reality image is driven by the virtual reality image.

According to a further aspect, the invention provides a virtual reality flight simulator comprising a test device according to any of the preceding aspects.

According to a further aspect, the invention provides a test method for testing function and/or use of a head worn see through augmented reality device by means of a virtual reality environment, comprising:

displaying virtual reality content on a virtual reality head mounted display through the see through augmented reality device to the eyes of a user.

Preferably, the method comprises aligning the see through augmented reality device and the virtual reality head mounted display of a head mounted device on a user's head, and

displaying virtual reality content on the virtual reality head mounted display through the see through augmented reality device to the eyes of the user and

displaying augmented reality content on the see through augmented reality device to the eyes of the user.

Preferably, the method comprises providing a virtual reality image of an outside world on the virtual reality head mounted display and providing additional semi-transparent augmented reality content on the see through augmented reality device and overlaying the augmented reality content to the virtual reality image.

Preferably, the method comprises aligning collimation distances of a virtual reality image displayed on the virtual reality display and of an augmented reality image displayed on the see through augmented reality device.

Preferably, the method comprises using different collimation distances of a virtual reality image displayed on the virtual reality display and of an augmented reality image displayed on the see through augmented reality device.

Preferably, the method comprises displaying the augmented reality content with a larger collimation distance and the same vergence angle as the virtual reality content.

Preferably, the method comprises evaluating optics of the see through augmented reality device by performing modifications on the virtual reality head mounted display.

Preferably, the method comprises tracking a position and/or orientation of a user's head and driving only the virtual reality content by the tracking information or driving both the virtual reality content and the augmented reality content by the tracking information.

Preferably, the method comprises testing the see through augmented reality device in a virtual flight simulator.

One aspect of the invention provides a testbed for head worn augmented reality applications and devices using a head mounted virtual reality environment.

The invention lies on the field of augmented reality applications and provides tools for testing the possible use and function of see through AR devices. Especially, the possible use and function in preferred AR applications is tested.

Some of these applications are:

Head Up Displays in cars

Information for manufacturing workers (e.g., AR working instructions)

Information for maintenance personnel (e.g., AR manuals)

Geo localized applications (Navigation, Points of interest)

displaying information to a pilot or a driver of a vehicle, especially an air vehicle.

One of the challenges in developing augmented reality applications is the tracking mechanism. In order to overlay information in real world environment, information on the position in this environment is advantageous. This tracking can be based on external sensors like optical or magnetic tracking systems; it can be based on internal sensors like GPS, a compass, accelerometers, or gyroscopes; or it can rely on a video feed of the real world.

After a technical implementation of an AR application, it should be evaluated in a realistic environment. It is especially advantageous to evaluate if the chosen tracking method and implementation work in different environments. In a laboratory it can be hard to create different realistic scenarios for this evaluation. Field-tests, on the other hand, are much more important but might be difficult because of limited time and resources (e.g., real flight tests).

In these cases, immersive virtual worlds can be a flexible low-cost alternative to create a realistic surrounding for evaluating AR applications. The concept of using virtual reality (VR) for evaluating AR applications was proposed by Tiefenbacher et al. in 2014, [1]. He describes how to utilize an expensive CAVE environment for the evaluation of handheld AR applications. This invention proposes a much cheaper and more flexible Head Mounted Display (HMD) to be used to visualize the virtual surrounding.

### BRIEF DESCRIPTION OF THE DRAWINGS

In the following, preferred embodiments of the invention are described with reference to the attached drawings, wherein

FIG. 1 is an exploded perspective view of a preferred embodiment of a test device for testing function and/or use of a head worn see through augmented reality device in a virtual reality environment;

FIG. 2 shows the exploded view from FIG. 1 as seen from above;

FIG. 3 is a further perspective view of the test device in use;

FIG. 4 is a further perspective view of the test device in use;

FIG. 5 is a schematic perspective view illustrating the impression of the user using the test device, wherein an outside visual virtual reality (VR) content and an AR content overlapped therewith is shown;

FIG. 6 is a schematic view illustrating the definition of a vergence angle a in the overlapped content of FIG. 5;

FIG. 7 is a schematic view illustrating different vergence angles that will lead to double images in the overlapped content of FIG. 5;

FIG. 8 is a schematic view illustrating same vergence angles but different collimation distances in the overlapped content such as given in FIG. 5;

FIG. 9 is a schematic view illustrating an overlapped content similar as in FIG. 5 with the ideal case of same collimation distance and vergence angle;

FIG. 10 is a block diagram illustrating use of external tracking both for virtual reality content as well as for augmented reality content;

FIG. 11 is a block diagram illustrating use of external tracking for the virtual reality content and internal tracking for augmented reality content;

FIG. 12 is a block diagram illustrating image based tracking wherein the augmented reality content is tracked in dependence from an image of the virtual reality content; and

FIG. 13 is a block diagram illustrating a virtual reality flight simulator environment.

### DETAILED DESCRIPTION OF THE PREFERRED EMBODIMENTS

In the following, preferred embodiments of a test device 10 for testing or evaluating a head worn see through augmented reality device 12 are described.

In the following the term “head worn device”—HWD 12—is used for the head worn see-through augmented reality device and the term “Head Mounted Display”—HMD 14 —is used for a display of a head mounted virtual reality device 16.

Hardware:

The head worn device 12 is the subject of the evaluation. There are different products on the market like the Epson BT-200. All these head worn devices 12 have transparent glasses 50 with semitransparent combiners 51 that project a screen/image in the field-of-view of the user 30. On these transparent screens/images 2D or 3D content is displayed to the user 30. Besides the visualization of information most of these head worn devices 12 also incorporate sensors like a 2D/3D front camera, accelerometers and/or a gyroscope. In the following, it is described how to evaluate different head worn devices 12. Yet, the design and the capabilities of the Epson BT-200 will be used as a reference.

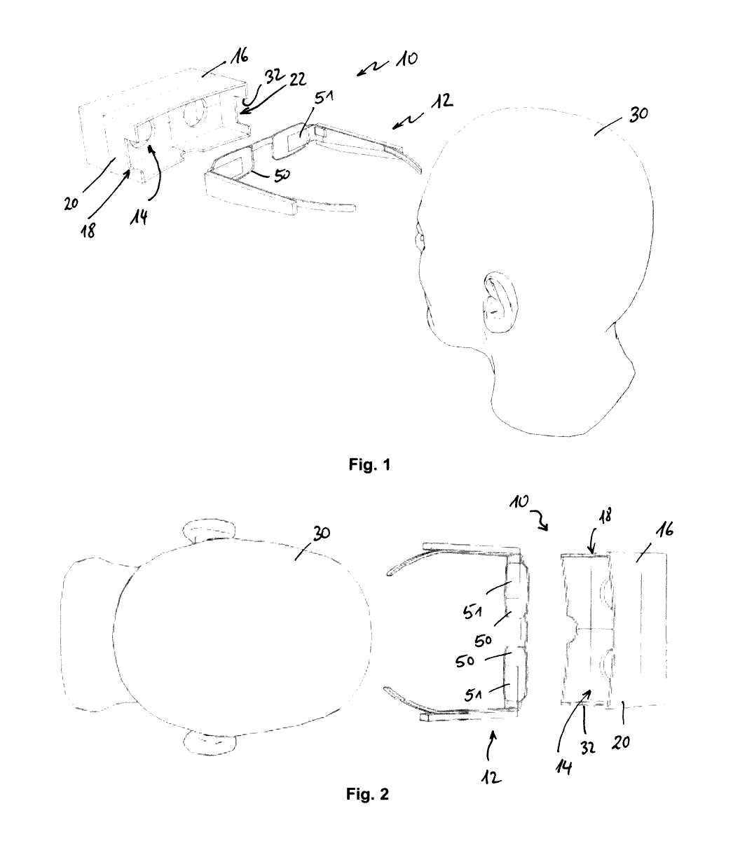

FIGS. 1 and 2 show the test device 10 comprising a head mounted device 16 with the virtual reality head mounted display 14 that is configured to display a virtual reality environment or a virtual reality content to the user 30.

Further, the test device 10 includes an alignment device 18 for aligning the HWD 12 and the HMD 14. For example, the head mounted device 16 has a housing 20, the binocular HMD 14, and a reception or a recess 22 adapted to receive and hold the HWD 12 relative to the HMD 14.

The HWD 12 is connected to a data processing equipment (not shown) configured to generate virtual reality content 26 to be displayed on the HMD 14. The HWD 12 is connected to a data processing unit (not shown) configured to generate augmented reality content 28 to be displayed in the field of view of the user.

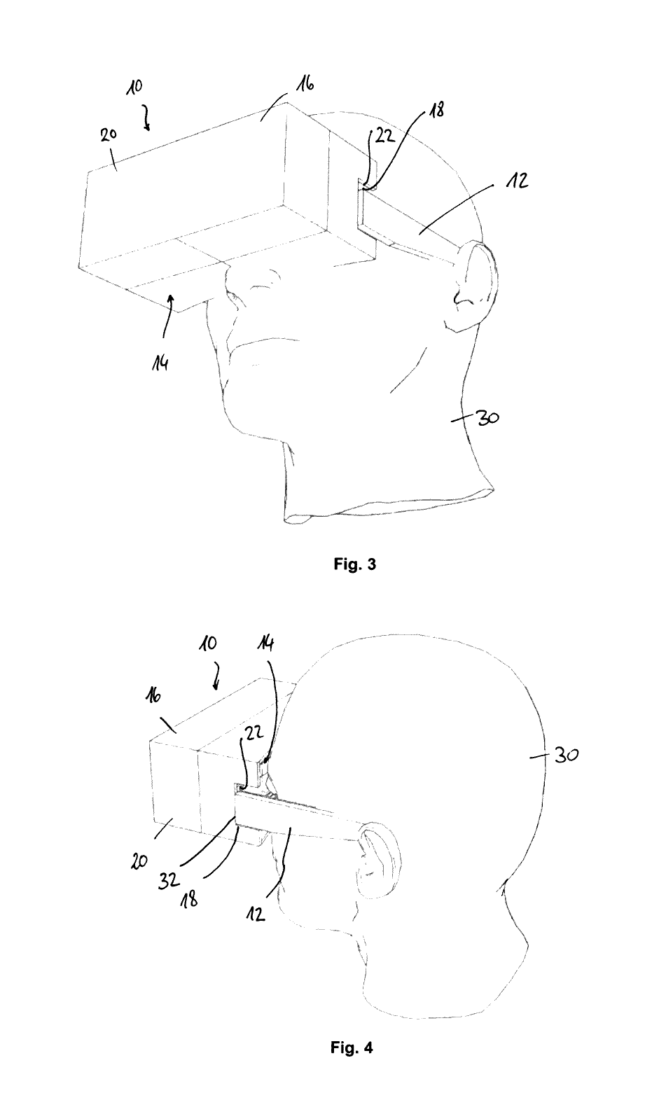

FIGS. 1 to 4 show the hardware that the user 30 has to wear when evaluating the head worn device 12. A HMD 14 that is modified compared to usual HMDs is used. From a design and ergonomic point of view, a slot 32 for holding the head worn device 12 can to be created to provide the recess 22. This slot 32 might be modified for different head worn devices 12. A flexible strap (not shown) should be added to hold the HMD 14.

Optics:

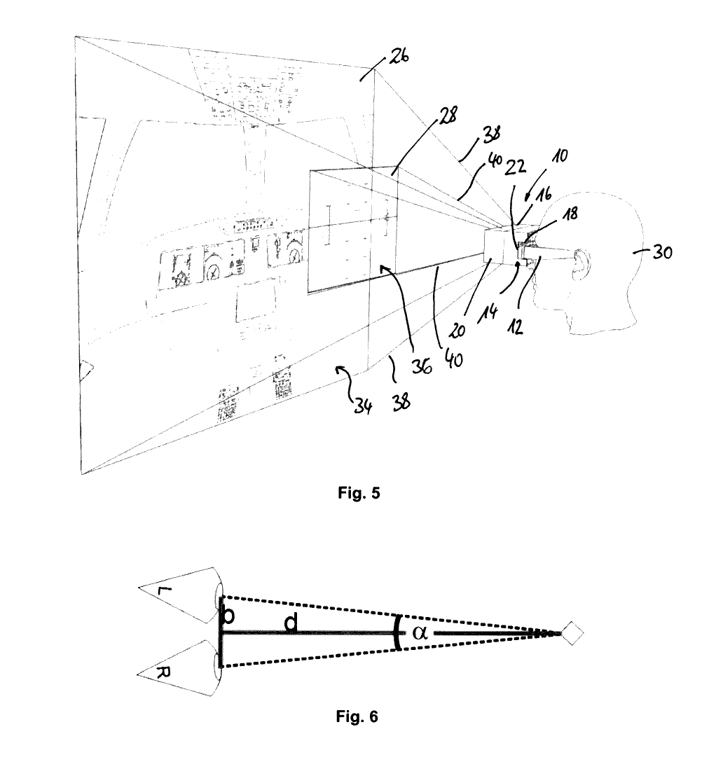

When combining the head worn device 12 and the head mounted display 14 the user is able to see two images 34, 36 that overlap in the field of view. The head mounted display 14 provides a virtual reality content 26, such as a virtual reality image 34 of the outside world, and the head worn device 12 provides additional semi-transparent AR content 28 (e.g., a semi-transparent augmented reality image 36) that is overlaid to the VR content. To provide a realistic experience to the user 30 the field of view 38 of the Virtual Reality (HMD 14) should be larger (or equal) than the field of view 40 of the AR (HWD 12) application. FIG. 5 illustrates this by providing a VR image 34 of a virtual reality environment of a cockpit and an AR image 36 of a head up display.

Overlapping the images 34, 36 of the two devices 12, 14 is not a straightforward task. Two parameters have to be aligned in order to make it usable: the collimation distance d and the vergence angle α. FIG. 6 illustrates the definition of these two parameter by illustrating the viewing direction of a left eye L and a right eye R of the user 30. It can be noted:

$$\begin{matrix}\frac{b \text{:} 2}{d} = tan ( α \text{:} 2 ) , \\ and & ( 1 ) \\ d = \frac{b \text{:} 2}{tan ( α \text{:} 2 )} \approx \frac{b}{tan ( α )} . & ( 2 )\end{matrix}$$

wherein b is the image distance, i.e., the distance between the image for the left and right eyes L, R.

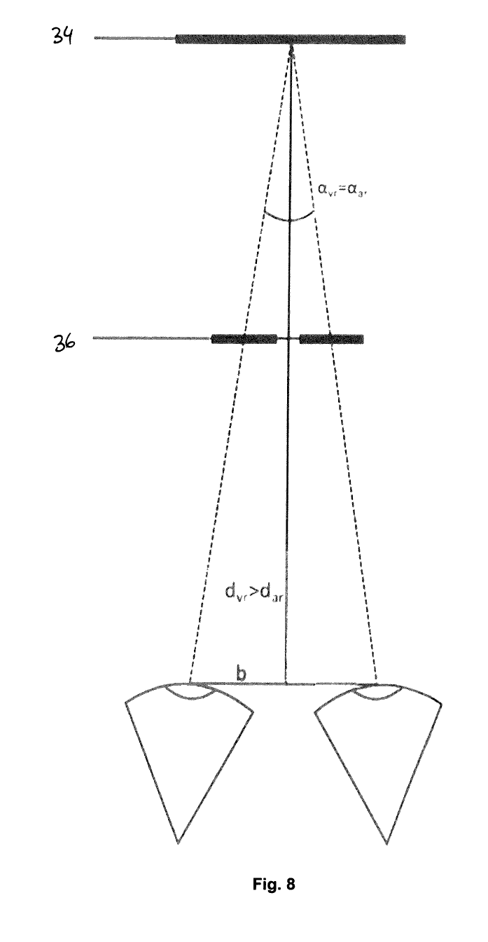

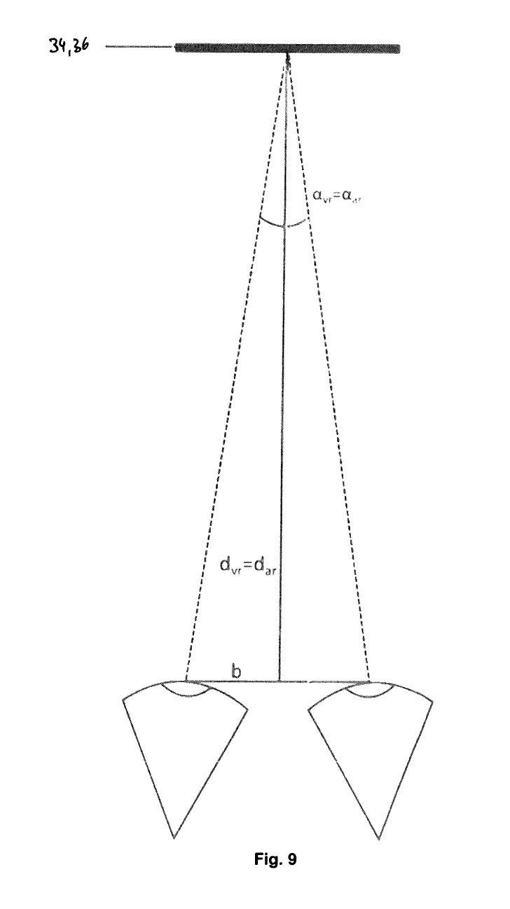

There are at least two parameters that define the image distance b of a binocular HMD 14 and the image distance of b a binocular HWD 12. First the image distance b is defined by the (projection) optics of the device and secondly it is defined by the vergence angle α of the stereo (left and right) image as shown in FIG. 9. Therefore, the values of the vergence angle αVR and αAr (Left and Right image of stereo image) of the HMD 14 and the HWD 12 have to be aligned to avoid double images. Otherwise if the subject/user accommodates on the AR image 36 the perception of the VR image 34 will be a double image and vice versa, see FIG. 8.

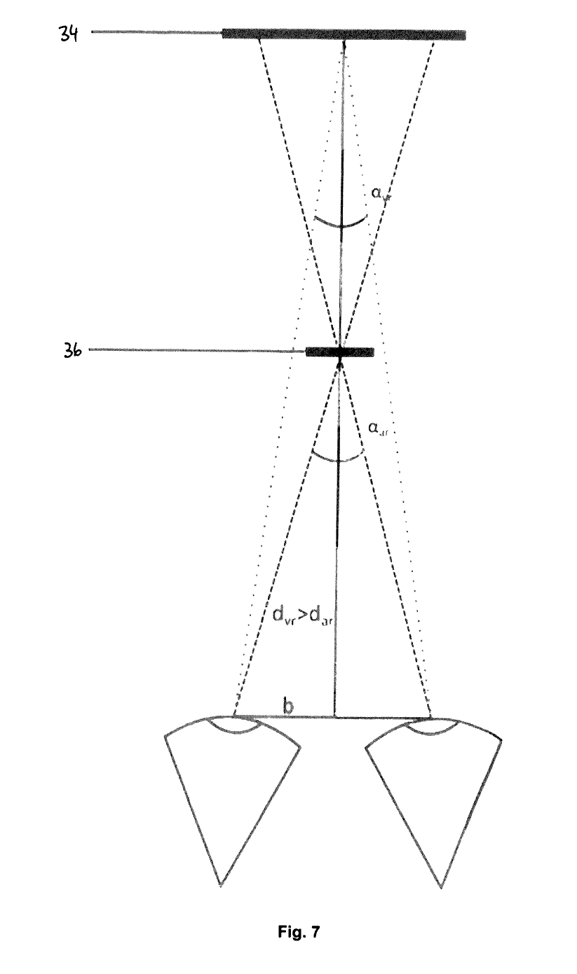

Second, the image distance b or collimation distance d of the optics (dVR and dAR) should be aligned in the two devices 12, 14 according to the application needs. Otherwise one of the pictures will get blurry while focusing on the other one, see FIG. 7, this may be difficult and maybe even not acceptable for some applications.

Using different collimation distances dAR and dVR (see FIG. 7) of the HMD 12 and HWD 14 might be desirable for a few applications and can be an advantage sense for the user e.g., for the head up display application.

In this case the HWD 12 with the head up display symbology should have a larger collimation distance than the HMD 14 (dVR>dAR), but the same vergence angle of the stereo images (αVR=αAR) to avoid double images, see FIG. 8. Such a setup would add a more realistic head up display application to VR application as in a real cockpit the pilot focusses the image of the head up display at infinity (approx. 20 m) looking outside the cockpit window.

In some cases, both parameters should be the same as shown in FIG. 9. In this case an adjustment of the parameters in the HWD 12 or HMD 14 should be possible to bring both parameters into alignment.

If not only the content of the head worn device 12, but also the optics should be evaluated, modifications should only be performed on the head mounted display 14. Or a head mounted display 14 should be chosen that matches the optical specifications of the head worn device 12.

Changing the vergence angle (αVR and αAR) of the head worn device 12 can be achieved by changing the distance of the image of the left eye L and the right eye R. This can be done on the software side by changing the image distance relative to each other on the microdisplay of the head worn device. Or it can be adjusted on the hardware.

Tracking:

In addition to the optics evaluation, also the tracking sensors can be analyzed with the proposed invention. Both, the augmented reality image 36 as well as the virtual reality image 34 rely on tracking information (position/orientation of the head) to create the image.

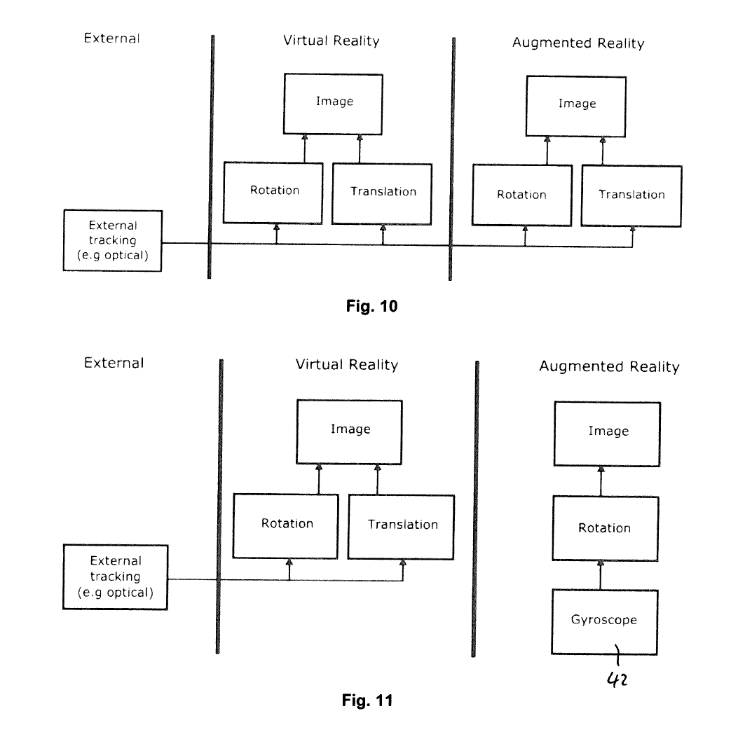

The most accurate tracking systems rely on external sensors to determine the position and rotation of the user's head. Consequently, the rotation and translation information for the virtual reality image 34 should be gathered from these external sensors. The same sensor information can be used to drive the image of the augmented reality device 36. FIG. 10 shows this sensor architecture.

To evaluate the accuracy of an internal sensor 42 (such as a gyroscope) of the head worn device 12 in the given AR application this sensor can be used to create the AR image 36. FIG. 11 shows this sensor architecture. As the internal sensor 42—gyroscope—does not provide translation information in this case, only rotation can be used for creating the AR image 36.

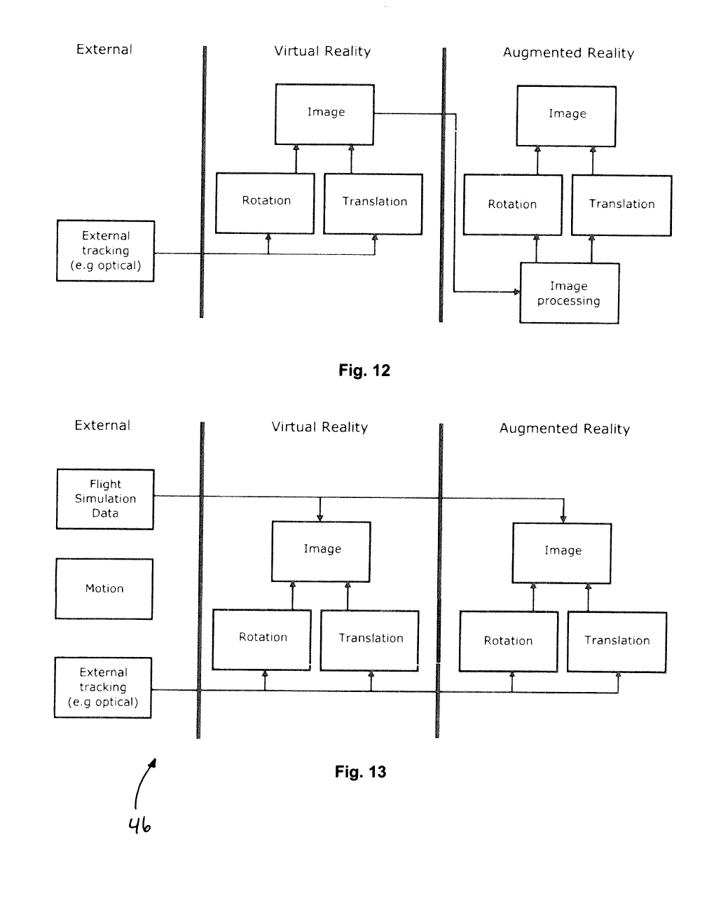

Some AR applications rely on video information of the environment captured by cameras located in front of the device. This real world image can be replaced by the VR image 34 to drive rotation and translation of the AR image 36 as illustrated in FIG. 12.

As an example for a use case, a head worn device evaluation in a Virtual Flight Simulator is described in the following, referring to FIG. 13.

A virtual reality flight simulator environment 46 has been developed in order to assess new cockpit and HMI concepts in an early design stage as this is described in more detail in the German patent application DE 10 2015 103 735.1, incorporated herein by reference. This environment 46 can be used to evaluate head worn devices 12 with conformal and non-conformal symbology (e.g., an artificial horizon, airspeed, altitude, etc.) In this case the AR device 12 needs information on simulated parameters. This data is provided by the flight simulation framework as a data pool that can be accessed by multiple components. To add realism to the system a motion platform is able to create forces and turbulences.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### LIST OF REFERENCES

10 test device
12 head worn see through augmented reality device—HWD
14 head mounted display—HMD
16 head mounted virtual reality device (head mounted device)
18 alignment device
20 housing
22 recess
26 virtual reality content
28 augmented reality content
30 user
32 slot
34 virtual reality image
36 augmented reality image
38 field of view of AR-HMD
40 field of view of AR-HWD
42 internal sensor, e.g., gyroscope
46 reality flight simulator environment
50 glasses
51 combiners

1. A test device for testing function and/or use of a head worn see through augmented reality device via a virtual reality environment, comprising:
a head mounted device including a virtual reality head mounted display configured to display the virtual reality environment to the eyes of a user through the head worn see through augmented reality device, and
an alignment device to align the head mounted display and the head worn see through augmented reality device.

2. The test device according to claim 1, wherein the alignment device comprises a positioning means for positioning the virtual reality head mounted display with regard to the see through augmented reality device.

3. The test device according to claim 1, wherein the head mounted device comprises one of a recess or slot configured to receive the see through augmented reality device in a positively engaged manner

4. The test device according to claim 1, wherein the head worn see through augmented reality device is configured to display an augmented reality content to the user and attached to the head mounted device.

5. The test device according to claim 4, wherein the virtual reality head mounted display has a field of view being larger than or equal to the field of view of the see through augmented reality device.

6. Test device according to claim 4, wherein the virtual reality head mounted display and the see through augmented reality device are configured such that the head mounted display displays a virtual reality content at least one of aligned or correlated with an augmented reality content displayed by the see through augmented reality device.

7. The test device according to claim 1, wherein the virtual reality head mounted display and the see through augmented reality device are binocular and are further characterized by at least one of the following features:
a) a collimation distance of the see through augmented reality device is smaller or equal to a collimation distance of the virtual reality head mounted display; or
b) the values of vergence angles of the see through augmented reality device and of the virtual reality head mounted display are aligned.

8. The test device according to claim 1, further including:
at least one tracking sensor configured to track at least one of a position or orientation of the head of the user,
wherein the virtual reality head mounted display is configured to display the virtual reality content in dependence of an output of the tracking sensor, and
wherein at least one of:
a) the test device is configured such that the same sensor information is used for driving both the image of the virtual reality head mounted display and the image of the see through augmented reality device; or
b) the test device is configured such that the sensor information of the tracking sensor is only used for driving the image of the virtual reality head mounted display, but not of the image of the see through augmented reality device, in order to test at least one of an internal position or orientation sensor of the see through augmented reality device.

9. A virtual reality flight simulator comprising a test device according to claim 1.

10. A test method for testing at least one of function or use of a head worn see through augmented reality device by means of a virtual reality environment, comprising:
displaying virtual reality content on a virtual reality head mounted display through the see through augmented reality device to the eyes of a user.

11. The test method according to claim 10, further comprising:
aligning the see through augmented reality device and the virtual reality head mounted display of a head mounted device on a user's head,
displaying virtual reality content on the virtual reality head mounted display through the see through augmented reality device to the eyes of the user, and
displaying augmented reality content on the see through augmented reality device to the eyes of the user.

12. The test method according to claim 10, further comprising at least one of the following steps:
a) providing a virtual reality image of an outside world on the virtual reality head mounted display and providing additional semi-transparent augmented reality content on the see through augmented reality device and overlaying the augmented reality content to the virtual reality image;
b) aligning collimation distances of the virtual reality image displayed on the virtual reality display and of the augmented reality image displayed on the see through augmented reality device,
c) using different collimation distances of a virtual reality image displayed on the virtual reality display and of an augmented reality image displayed on the see through augmented reality device;
d) displaying the augmented reality content with a larger collimation distance and the same vergence angle as the virtual reality content;
e) evaluating optics of the see through augmented reality device by performing modifications on the virtual reality head mounted display;
f) tracking a position and/or orientation of a user's head and driving only the virtual reality content by the tracking information or driving both the virtual reality content and the augmented reality content by the tracking information;
g) testing the see through augmented reality device in a virtual flight simulator.
